(19) United States
(12) Patent Application Publication
(10) Pub. No.: US 2022/0238900 A1
(43) Pub. Date: Jul. 28, 2022

(54) All Natural Redox Flow Battery Utilizing Indigo Carmine And Derivatives Thereof

(71) Applicant: Northeastern University, Boston, MA (US)

(72) Inventor: Hongli ZHU, Arlington, MA (US)

(21) Appl. No.: 17/613,591

(22) PCT Filed: Jun. 10, 2020
(86) PCT No.: PCT/US2020/036954

§ 371 Date: Nov. 23, 2021

Related U.S. Application Data
(60) Provisional application No. 62/859,832, filed on Jun. 11, 2019.

(51) Int. Cl. H01M 8/08; H01M 8/18

(52) U.S. Cl. CPC H01M 8/08; H01M 2300/0005; H01M 8/188

(57) ABSTRACT

Redox flow batteries that utilize indigo carmine and derivatives thereof as electrolytes are disclosed.

### RELATED APPLICATION

This application claims the benefit of U.S. Provisional Application No. 62/859,832, filed on Jun. 11, 2019. The entire teachings of the above application(s) are incorporated herein by reference.

### BACKGROUND

The rapid growth of renewable energy sources such as wind and solar energy can supply a significant amount of electricity all over the world^{[1]}, but their inherent intermittency and fluctuating nature is one of the essential barriers to utilize this enormous amount of electricity available from renewable sources.^{[2]} This intermittent nature of renewable sources led to an emerging need for efficient, cost-effective, and sustainable grid storage technologies. Redox flow batteries (RFBs) are particularly attractive and suitable for grid storage as they can scale power and energy independently.^{[3]} Although the RFBs have been recognized as a viable technology for reliable and extended duration grid scale load deferment, the extensive utilization of the RFBs has been limited by the toxicity and lack of natural abundance of the inorganic electrolytes.^{[4]}

### SUMMARY

Organic redox flow batteries have the potential to surpass the challenges posed by inorganic electrolytes commonly used in flow batteries, thus achieving high performance and a sophisticated storage solution for the grid. Herein, we demonstrated a high performance aqueous organic redox flow battery (AORFB) utilizing a redox active resource from nature, indigo carmine (5,5′-indigodisulfonic acid sodium salt) (IC-Na), as the anolyte. The 5,5′-indigodisulfonic acid (IC-H) is obtained through the substitution of sodium ions in IC-Na with protons (H⁺). The aqueous solubility of IC-H was increased dramatically from 0.035 M to 0.760 M in protic solvents by enhancing hydrogen bonding. The revealed diffusion coefficients (IC-Na: 3.38×10⁻⁵ and IC-H: 2.23×10⁻⁵ cm² s⁻¹) and reaction rate constants (IC-Na: 2.32×10⁻⁴ and IC-H: 2.82×10⁻⁴ cm s⁻¹) indicate rapid reaction kinetics. The highly soluble IC-H constructs high-performance AORFB, when paired with bromine/hydrobromic acid catholyte, exhibiting high capacity of 24.2 Ah L⁻¹ at 40 mA cm⁻² with round-trip energy efficiency and capacity retention exceeding 77.0% and 99.5% per day. Moreover, computational study signifies the prospect of further improvements in solubility and voltage window by tuning the structure. Therefore, the environmentally benign and earth-abundant IC-H represents a promising choice for green and sustainable redox active anolyte of AORFB.

Described herein is a redox flow battery. The redox flow battery includes a first compartment with a first electrode and a first solvent or suspension therein. The first solvent or suspension includes a first electrolyte dissolved or suspended therein. The redox flow battery includes a second compartment with a second electrode and a second solvent or suspension therein. The second solvent or suspension includes a second electrolyte dissolved therein. The redox flow battery also includes an ion conducting membrane separating the first solvent or suspension and the second solvent or suspension.

The second electrolyte is a compound having the following structural formula:

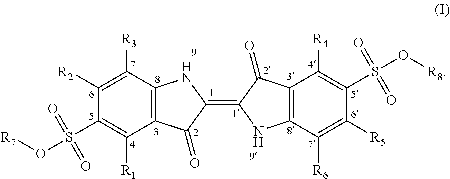

Each of R₁-R₆ is independently —H, —OH, —CH₃, —OCH₃, —COOH, or —SO₃H. Each of R₇ and R₈ is independently H, Na, or K.

In some embodiments, R₇ and R₈ are H. In some embodiments, R₇ and R₈ are Na. In some embodiments, R₇ and R₈ are K.

In some embodiments, each of R₁-R₆ is H.

In some embodiments, each of R₁-R₈ is H.

In some embodiments, each of R₁-R₆ is H; and R₇ and R₈ are Na.

In some embodiments, one or more of R₁-R₆ is —OH.

In some embodiments, the first solvent or suspension further includes HClO₄. In some embodiments, the second solvent or suspension further includes HClO₄. In some embodiments, the first or second solvent or suspension has a pH from 2 to 6. In some embodiments, the first or second solvent or suspension includes water. In some embodiments, the second solvent or suspension is a protic solvent. In some embodiments, the protic solvent includes one or more of HClO₄, H₂SO₄, and HCl.

In some embodiments, the first electrolyte includes one or more of Br₂, HBr, and Br⁻. In some embodiments, the first electrolyte includes TEMPO.

Described herein is a method of operating a redox flow battery. The method includes flowing a first solvent or suspension from a first storage tank to a first compartment. The first solvent or suspension includes a first electrolyte dissolved or suspended therein. The method also includes flowing a second solvent or suspension from a second storage tank to a second compartment. The second solvent or suspension includes a second electrolyte dissolved or suspended therein. The second electrolyte is a compound having the following structural formula:

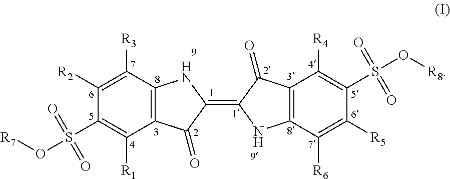

Each of R₁-R₆ is independently —H, —OH, —CH₃, —OCH₃, —COOH, or —SO₃H. Each of R₇ and R₈ is independently H, Na, or K.

The method can further include generating electricity across a circuit connecting a first electrode and a second electrode. The first electrode can contact the first solvent or suspension and the second electrode can contact the second solvent or suspension. Generating electricity across the circuit can include powering a load or recharging the redox flow battery.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a plant of the Indigofera genus from where the parent dye indigo can be extracted. FIG. 1B is a schematic illustration of the ion exchange mechanism of IC-Na using amberlyst H resin. FIG. 1C is a structural illustration of IC-Na participating in a redox reaction by accepting and releasing two electrons and two protons. FIG. 1D is a schematic representation of the IC-H/Br₂ flow cell diagram.

FIGS. 2A-E illustrate electrochemical half-cell measurements of IC-Na and IC-H. FIG. 2A is cyclic voltammograms of IC-Na recorded between −0.1 V to 0.3 V vs. Ag/AgCl at scan rates from 5 mV s⁻¹ to 200 mV s⁻¹. FIG. 2B is a graph showing dependence of the redox peak currents on scan rates for IC-Na. FI. 2C is cyclic voltammograms of IC-Na cycled for 500 times at 40 mV s⁻¹ scan rate. FIG. 2D is cyclic voltammograms of IC-H recorded between −0.2 V to 0.4 V vs. Ag/AgCl at scan rates ranging from 5 mV s⁻¹ to 200 mV s⁻¹. FIG. 2E is a graph showing dependence of the redox peak currents on scan rates for IC-H. FIG. 2F is cyclic voltammograms of IC-H cycled for 10,000 times at 40 mV s⁻¹ scan rate.

FIG. 3A shows rotating disk electrode measurements of 1 mM IC-Na solutions in 0.1 M HClO₄ at nine rotation speeds ranging from 300 rpm to 2700 rpm with an increment of 300. FIG. 3B shows rotating disk electrode measurements of 1 mM IC-H solutions in 0.1 M HClO₄ at nine rotation speeds ranging from 300 rpm to 2700 rpm with an increment of 300. FIG. 3C is a Levich plot (limiting current vs. sq. root of rotation) of IC-Na and IC-H, which are derived from FIGS. 3A and 3B, respectively. FIG. 3D is a plot of overpotential versus the logarithm of kinetic current and the corresponding fitted Tafel plots for IC-Na. FIG. 3E is a plot of overpotential versus the logarithm of kinetic current and the corresponding fitted Tafel plots for IC-H.

FIG. 4A is a plot of Electrochemical Impedance Spectroscopy (EIS) of IC-H—/Br₂ cell within a frequency range of 1 M Hz to 10 mHz. FIG. 4B is a plot of cell voltage vs. current density of IC-Na and IC-H cells when paired against Br₂/HBr. The polarization resistances were determined from the slope of the fitted curves of charge and discharge. FIG. 4C is a plot showing variation in open circuit voltage (OCV) of IC H/Br₂ cell at a different SOC. FIG. 4D is UV-Vis spectra of IC-H at different SOC ranging from 0% to 100% during the charging process of the IC-H/Br₂ cell at 40 mA cm⁻² with an upper cut off voltage of 1.4 V.

FIGS. 5A-D demonstrate full cell performance of 0.035 M IC-Na in 0.1 M HClO₄ against 0.5 M Br₂ in 3 M HBr. FOG. 5A shows cycle number versus capacity plot at various current densities. FIG. 5B shows capacity versus cell voltage traces at different current densities.

FIG. 5C is plots of averaged discharge capacity (circle), columbic efficiency (square), voltage efficiency (rhombus), energy efficiency (sphere) versus current density of the IC-Na/Br₂ cell.

FIG. 5D shows constant current cycling of IC-Na/Br₂ cell at a current density of 40 mA cm⁻² with a cut off voltage of 1.4 V during charge and 0.2 V during discharge.

FIGS. 6A-D demonstrate full cell performance of 0.7 M IC-H in 0.2 M HClO₄ against 0.5 M Br₂ in 3 M HBr. FIG. 6A shows cycle number versus capacity plot at various current densities ranging from 40 mA cm⁻² to 150 mA cm⁻². FIG. 6B shows capacity versus cell voltage traces at different current densities. FIG. 6C is plots of averaged discharge capacity (pink triangle), columbic efficiency (purple circle), voltage efficiency (green rectangle), energy efficiency (orange rhombus) versus current density of the IC-H/Br₂ cell. FIG. 6D shows constant current cycling of IC-H/Br₂ cell at a current density of 20 mA cm⁻² with a cut off voltage of 1.4 V during charge and 0.2 V during discharge.

FIG. 7A is an electrostatic potential map of IC-Na. FIG. 7B is plots of predicted redox potential vs. solvation energy after addition of different functional groups, such as electron donating groups (1-18) hydroxyl (1-6), methyl (7-12), and methoxy (13-18) and electron withdrawing groups (19-30) carboxyl (19-23) and sulfonate (24-30). The black and blue dotted line represents the solvation energy of pristine IC-Na without any substitution and hydrogen substituted IC-H, respectively. The numbering corresponds to the substitution patterns shown in Table 1.

FIG. 8 is a graph showing dynamic viscosity at varying temperature for 0.7 M IC-H at two different shear rates of 5/s and 2/s.

FIGS. 9A-D are a demonstration of full cell performance of 0.035 M IC-Na in 0.1 M HClO₄ against 0.25 M 4-acetamidoTEMPO in 0.1 M HClO₄. FIG. 9A shows Electrochemical Impedance Spectrum of IC-Na/TEMPO cell. (b) Capacity versus cell voltage traces at different current densities. (c) Cycle number versus capacity plot at various current densities. FIG. 9D shows constant current cycling of IC-Na/TEMPO cell at a current density of 20 mA cm⁻² with a cut off voltage of 1.3 V during charge and 0.2 V during discharge.

FIGS. 10A-D are a demonstration of full cell performance of 0.7 M IC-H in 0.2 M HClO₄ against 0.5 M TEMPO in 0.1 M HClO₄. (a) Cycle number versus capacity plot at various current densities. (b) Capacity versus cell voltage traces at different current densities. (c) Variation in coulombic efficiency with current density. (d) Constant current cycling of IC-H/TEMPO cell at a current density of 40 mA cm⁻² with a cut off voltage of 1.2 V during charge and 0.2 V during discharge.

FIG. 11 shows XRD of IC-Na and IC-H indicating a change in the crystalline structure of IC-Na and IC-H.

### DETAILED DESCRIPTION

A description of example embodiments follows.

### Introduction

To overcome these limitations encountered by the existing inorganic RFBs, researchers demonstrated several promising organic and organometallic electrolyte materials^{[4-6, 7-10]} as they have the potential to surpass the challenges of inorganic flow batteries and lead to a sophisticated storage solution for the grid.^{[11]} For instance, anthraquinone and its derivatives have been studied extensively for their rapid redox kinetics and chemical stability.^{[6, 12]} Our previous study also utilized the redox chemistry of quinone in ultrafiltered lignin to construct a low cost and earth-abundant electrolyte for AORFB.^{[5]} The redox activities of other stable organic molecules such as TEMPO (2,2,6,6-tetramethylpiperidine-1-oxyl)^{[8, 9]}, viologens^{[4, 8, 10, 13]} alloxazine^{[2]}, and ferrocene^{[4]} were also investigated to demonstrate novel high-performance RFBs. Despite the substantial advances in organic electrolytes, only a small number of AORFB take advantage of organic redox active compounds for the electrolytes due to their low energy densities, poor stability, the high cost of the electrolytes, and lack of abundance in nature. Therefore, the key to reduce the capital cost and the environmental impact of the AORFB is the utilization of abundant and ubiquitous natural resources to obtain a cost-effective and nontoxic electrolyte.

Herein, we introduce an earth-abundant, and redox active natural polymer IC-Na (5,5′-indigodisulfonic acid sodium salt) from nature as a promising anolyte for AORFB to curtail the cost of the electrolytes, eliminate complicated synthesis processes, and simultaneously diminish the concern of availability for large-scale storage.^{[14]} Although the redox property of IC-Na has been studied before,^{[15]} the performance evaluation of IC-Na and IC-H in flow cell has never been done. IC-Na, a water-soluble derivative of the naturally occurring indigo dye, has been used since the ancient times for dyeing and printing^{[16]} and can be obtained from more than 50 different species of plants.^{[17]} Meanwhile, IC-Na is authorized for a wide range of food categories with maximum permitted levels between 50 and 500 mg kg⁻¹ of food,^{[18]} which identifies the benignity of IC-Na. Other favorable features of IC-Na include a highly rapid and reversible redox reaction, excellent stability, and structural modularity that are absolutely necessary for an anolyte of an AORFB.

However, the major challenge of using pristine IC-Na as an electrolyte directly in the flow battery is its poor aqueous solubility (10 g L⁻¹). A scalable ion exchange process is performed to overcome this limitation by replacing the sodium ions with protons in the IC-Na^{[15]} that leads to a significant improvement (22 folds) in solubility (from 0.035 M to 0.760 M in 0.1 M HClO₄), owing to the intermolecular hydrogen bond formation in protic solvents. With this high solubility, the obtained IC-H yields a theoretical volumetric capacity of 37.0 Ah L⁻¹ with a theoretical energy density of 28.2 Wh L⁻¹. The IC-H can achieve a capacity of 24.2 Ah L⁻¹ at 40 mA cm⁻² with the round-trip energy efficiency of 77% and capacity retention of 99.96% per cycle, by pairing it up with a Br₂/HBr catholyte. In addition, the IC-H obtained a capacity of 13 Ah L⁻¹ at 40 mA cm⁻² when paired with TEMPO. To further raise the solubility and voltage window, a high throughput computational study was also conducted to determine the optimum position and the type of the functional group that lowers the redox potential of the IC-Na and further increases the solubility.

### Redox Flow Batteries

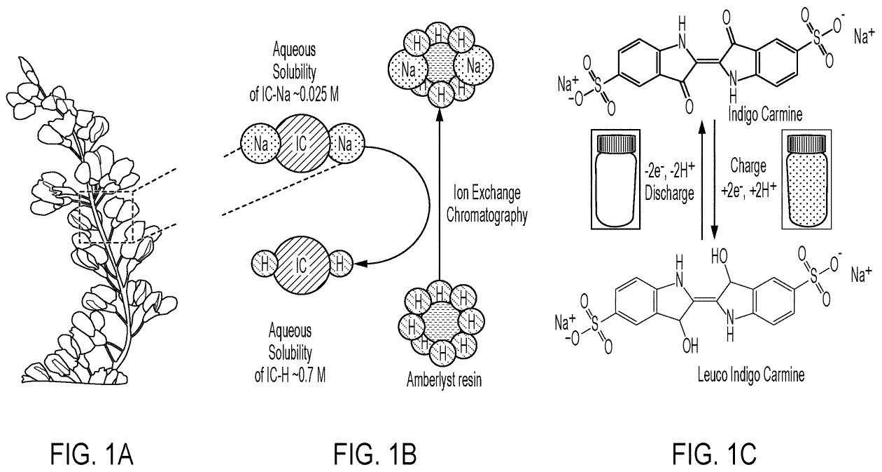

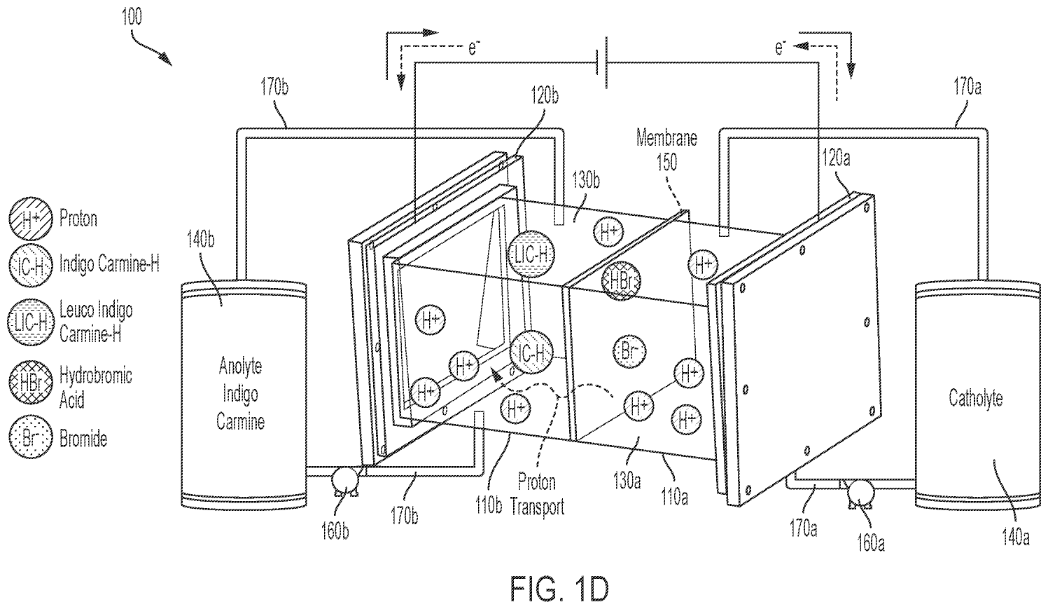

An example of a redox flow battery 100 is shown in FIG. 1D. The redox flow battery includes an enclosure 110, which has a first compartment 110a and a second compartment 110b that are separated by an ion-conducting membrane 150.

Within the first compartment 110a is a first electrode 120a that contacts a first solvent or suspension 130a. The first solvent or suspension has a first electrolyte dissolved or suspended therein. As illustrated, first compartment 110a houses the catholyte.

Within the second compartment 110b is a second electrode 120b that contacts a second solvent or suspension 130b. The second solvent or suspension has a second electrolyte dissolved or suspended therein. As illustrated, second compartment 110b houses the anolyte.

The first and second electrodes can be electrically connected to form an electrical circuit, as indicated by the electron path shown in FIG. 1D.

Typically, first and second tanks (140a, 140b) that store additional solvent or suspension are utilized to increase the volume of solvent or suspension (130a, 130b). One or more pumps (160a, 160b) can also be used to circulate the solvents or suspensions (130a, 130b) from the tanks (140a, 140b) to the first and second compartments (110a, 110b) via suitable tubing or piping (170a, 170b).

For a redox flow battery, power density is proportional to the surface area of the ion-conducting membrane 150 and the surface area of the electrodes (120a, 120b). Energy density is proportional to the volume of anolyte and catholyte stored in the first and second tanks (140a, 140b).

### Electrolytes

Disclosed are electrolyte compounds, which can be used as an anolyte in a redox flow battery. The electrolyte compounds have Structural Formula (I.1):

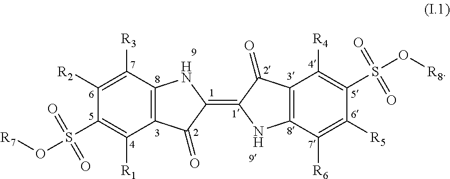

Each of R₁-R₆ is independently H, —OH, —CH₃, —OCH₃, —COOH, or —SO₃H. Each of R₇ and R₈ is independently H, Na, or K.

In some embodiments, each of R₇ and R₈ is H, and the compound of Structural Formula (I.1) is a compound having Structural Formula (I.2):

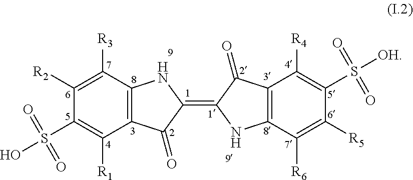

In some embodiments, the compound of Formula (I.2) is in its ionic form and is a compound having Structural Formula (I.3):

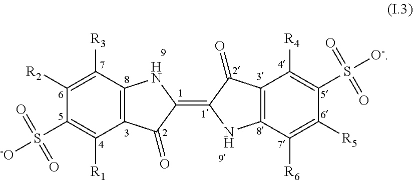

In some embodiments, the compound of Structural Formula (I.2) and/or Structural Formula (I.3) has a counterion, such as sodium (Nat) or potassium (K⁺). In one embodiment, the compound of Structural Formula (I.2) and/or Structural Formula (I.3) has a sodium counterion and is a compound having Structural Formula (I.4):

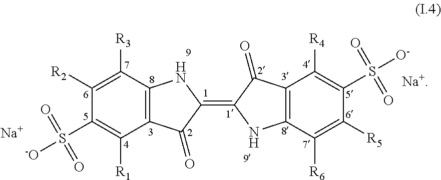

In some embodiments, each of R₁-R₆ is H, and the compound of Formula (I.1) has the following structural formula:

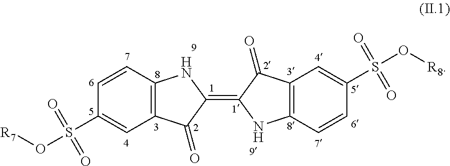

In some embodiments, each of R₇ and R₈ is H, and the compound of Structural Formula (II.1) is a compound having Structural Formula (II.2):

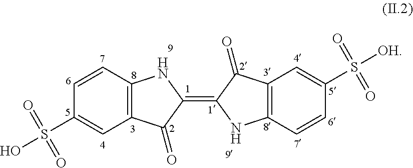 [SMILES: O=C1/C(=C2\Nc3ccc(S(=O)(=O)O)cc3C2=O)Nc2ccc(S(=O)(=O)O)cc21]

The compound having Structural Formula (II.2) is referred to herein as IC-H.

In some embodiments, the compound of Formula (II.2) is in its ionic form and is a compound having Structural Formula (II.3):

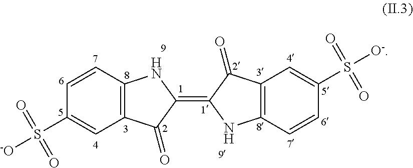

In some embodiments, the compound of Structural Formula (II.2) and/or Structural Formula (II.3) has a counterion, such as sodium (Nat) or potassium (K⁺). In one embodiment, the compound of Structural Formula (II.2) and/or Structural Formula (II.3) has a sodium counterion and is a compound having Structural Formula (II.4):

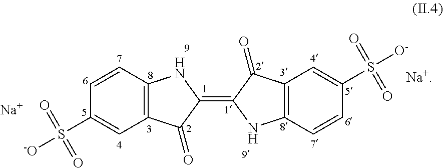

The compound having Structural Formula (II.4) is referred to herein as IC-Na.

In a redox flow battery, the electrolytes are dissolved in a solvent or in a suspension. The compounds, ions thereof, and salts thereof may be present as a mixture. For example, compounds having Structural Formula (I.1) may be present as a mixture of compounds having Structural Formulas (I.2), (I.3), and (I.4). The compounds having Structural Formula (II.1) may be present as a mixture of compounds having Structural Formulas (II.2), (II.3), and (II.4). Compounds having Structural Formulas (I.1), (I.2), (I.3), and (I.4) can be mixed with compounds having Structural Formulas (II.1), (II.2), (II.3), and (II.4).

Additional electrolyte compounds suitable for use as an anolyte are described in Table 1.

Electrolytes suitable for use as a catholyte in the redox flow batteries are known in the art. One example is Br₂/HBr, which undergoes a reversible reaction as follows:

Br₂+2H⁺+2e⁻↔2HBr↔2H⁺+2Br⁻

The electrolytes for use as an anolyte and for use as a catholyte can be present at a concentration from about 0.1 M to about 10 M. In some embodiments, the electrolyte can be present at a concentration from about 0.5 M to about 1.5 M. In some embodiments, the electrolyte can be present at a concentration of about 0.7 M.

### Supporting Electrolytes

In addition to the electrolytes disclosed herein, the solvent or suspension can include one or more supporting electrolytes, which can increase proton conductivity across the ion-conducting membrane 150. One or more supporting electrolytes can be included in the first compartment 110a, the second compartment 110b, or both. The solvent can include other acids (e.g., HClO₄⁻; HCI) or bases (e.g., NaOH or KOH) or alcohols (e.g., methyl, ethyl, or propyl) and other co-solvents to increase the solubility of the electrolytes. In certain embodiments, the pH of the solvent can be about 2 to about 6. The solvent can be buffered to maintain a specified pH. The first electrolyte and the second electrolyte are present in concentrations suitable for operation of a redox flow battery, for example, from about 0.05 M to about 1 M. In some embodiments, the supporting electrolyte is present at a concentration from about 0.05 M to about 0.5 M. In some embodiments, the supporting electrolyte is present at a concentration of about 0.1 M. In some embodiments, the solution is at least 10%, 20%, 30%, 40%, 50%, 60%, 70%, or 80% solvent (e.g., water), by mass.

### Electrode

A variety of electrodes are suitable for use in redox flow batteries in conjunction with the organic electrolytes described herein. Examples of electrode materials include carbon electrode, such as glassy carbon electrodes, carbon paper electrodes, carbon felt electrodes, and carbon nanotube electrodes. Other suitable electrodes include titanium electrodes.

### Membrane

An ion conducting membrane is disposed between the first solvent and the second solvent. The membrane allows passage of small ions, such as hydrogen, sodium, or potassium, but does not permit passage of the compounds of formulas (I)-(III). Ion conducting membranes are known in the art. One suitable ion conducting membrane is a NAFION® membrane, which is a sulfonated tetrafluoroethylene based fluoropolymer-copolymer.

### EXEMPLIFICATION

### Results and Discussion

FIG. 1A illustrates the natural source of the indigo dye. The most natural product from which indigo is obtained includes indican (genus indigofera plants) and isatan (woad plants or isatis tinctoria) in tropical and moderate climate zones, respectively.^{[19]} Irrespective of their source, the chemistry of the dye extraction involves soaking the leaves of the plants in water to facilitate the fermentation process, during which the indican readily undergoes enzymatic hydrolysis and releases indoxyl that converts to indigo by oxidation upon exposure to air. IC-Na can be obtained from indigo by sulfonation, which renders the compound water-soluble by attaching two sulfonic acid groups to the indigo core.^{[20]} However, sulfonating indigo to form IC-Na is not sufficient to obtain a high concentration of the electrolyte for the AORFB due to the extensive π stacking of IC-Na, which limits its application in AORFB. On the contrary, a high concentration of reactants in solution is the key to minimize the storage tank size while obtaining high specific volumetric energy density. Therefore, the design of an appropriate electrolyte for AORFB starts from identifying redox-active materials followed by optimization of the structure to achieve the maximum solubility to maximize the energy density. In this study, in order to increase the solubility of IC-Na, it was converted to its acid analog (IC-H) by replacing the sodium ions in IC-Na with protons by passing through a column packed with amberlyst 15 hydrogen resins (FIG. 1B).^{[15]} The conversion of IC-Na to IC-H was conducted on a large scale with more than 90% yield, and the solubility of the obtained IC-H is 0.76 M in 0.1 M HClO₄ owing to the intermolecular hydrogen bond formation. In IC-H, the substituted protons are attached to the strongly electronegative oxygen atoms and capable of forming strong hydrogen bondings. Hydrogen bondings are usually stronger than the Van Der Wall forces and dipole interactions. Thus, the highly polar IC-H exhibits high intermolecular forces between the solute and the protic solvents and increases the solubility drastically. FIG. 1C schematically illustrates the structure, redox mechanism of IC-Na with the release and accepting of two electrons and two protons, and appearance at different oxidation states in an acidic medium. IC-Na accommodates two electron transfer leading to exceptional capacities. It undergoes a rapid and highly reversible reduction and oxidation to form leucoindigoid species (LIC-Na), which makes it suitable for its application as an anolyte in AORFB.^{[21]} IC-Na contains a C═C bridged structure with one six-membered and another five-membered aromatic ring on each side. IC-Na is a blue crystalline powder with a purplish luster due to the conjugation of the double bonds^{[22}] and in the molecular structure of organic crystal IC-Na, electron donor groups (—NH and —OH) and electron acceptor group (C═O) are attached by conjugated bonds, which are responsible for the dark blue shade of the IC-Na. In the reduced state, the dark blue color of the IC-Na changes to green, as shown in FIG. 1C. To demonstrate the full cell performance of IC-H in the AORFB, we paired IC-H with Br₂/HBr, as depicted in FIG. 1D. The IC-Na/Br₂ and IC-H/Br₂ batteries were assembled by stacking pretreated carbon paper electrodes at both sides separated by a NAFION® proton exchange membrane and the solutions of IC-Na (0.035 M IC-Na in 0.1 M HClO₄) and IC-H (0.7 M IC-H in 0.2 M HClO₄) in perchloric acid were pumped through the negative side, while the Br₂/HBr (0.5 M Br in 3.0 M HBr) was pumped through the positive side of the cells, respectively. In order to evaluate the performance of IC-Na and IC-H as anolytes of AORFB, an excess quantity of catholyte was used in the positive side to ensure that the anolyte stays the capacity limiting side all the time.

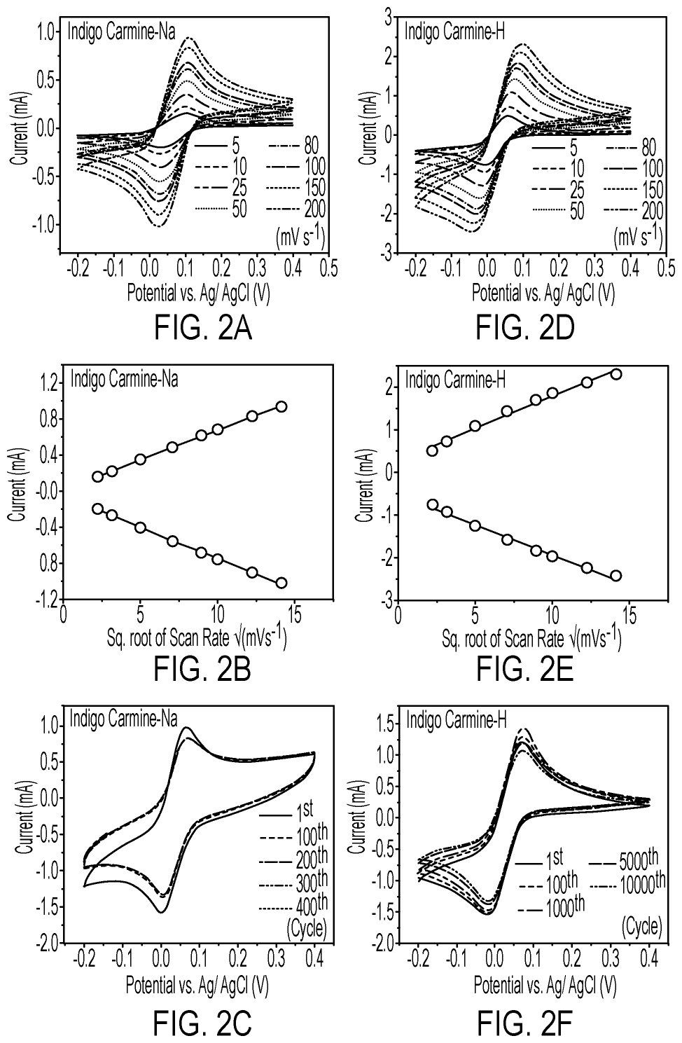

To achieve a better understanding of the redox reaction, electrochemical measurements in a half-cell were obtained for both IC-Na and IC-H. As illustrated in FIG. 2A, cyclic voltammetry (CV) of IC-Na displays a pair of sharp and well-defined cathodic peak at ˜0.0 V and anodic peak at ˜0.035 V vs. Ag/AgCl at varying scan rates with a peak separation of 0.035 V, which is close to the theoretically expected value of 0.0295 V (0.059 V/n, n being two since two electrons are involved in the reaction), corresponding to the reversible reduction and oxidation of IC-Na to LIC-Na.^{[23]} The conversion of the IC-Na to LIC-Na depends on the two electron enolization process, where the two ketone groups containing IC-Na converts to two enol groups containing LIC-Na by two successive symmetric protonation processes.^{[24]} FIG. 2B demonstrates the dependence of the redox peak current for the reduction (red line) and oxidation (blue line) on scan rate, which shows a linear behavior indicating a diffusion controlled process for IC-Na. In addition, the CV of IC-Na was also cycled 500 times, as shown in FIG. 2C. It is worth mentioning that the reduced state of IC-Na (LIC-Na) is sensitive to the oxygen and the solution was sparged with nitrogen before starting the experiment and sealed properly to avoid oxygen exposure. The obtained CV curves of 100^{th}, 200^{th}, 300^{th}, 400^{th}, and 500^{th} cycles exactly overlap, which can be attributed to the excellent reversibility of the IC-Na due to its mesomeric structure and intramolecular hydrogen bonding. However, a shrinkage in peak size after the first cycle was observed and was attributed to the dissolved oxygen in the water.

The IC-H also displays a sharp pair of redox peaks centering around 0 V vs. Ag/AgCl and separated by 40 mV at varying scan rates ranging from 5 mV s⁻¹ to 200 mV s⁻¹ (FIG. 2D), which can be attributed to the rapid and reversible reduction and oxidation of IC-H to the acid analog of leuco indigo carmine (LIC-H). The scan rate dependence of redox peaks for IC-H also displays a linear behavior (FIG. 2E), similar to the IC-Na, indicating a diffusion-controlled process. However, compared to IC-Na (FIG. 2B), IC-H generates 10 times higher current under the same scan rate.

In addition, the CV of IC-H was cycled 10,000 times at 40 mV s⁻ (as illustrated in FIG. 2F) and a negligible decay observed after this extensive CV cycling that indicates high chemical stability attributable to the mesomer structure of the IC-H and its capability of forming hydrogen bonding. The structural analysis of indigo derivatives, conducted by Solis Correa et al. suggested the existence of two intramolecular hydrogen bonds between the adjacent ketone and the amine groups that inhabit the positions, which would otherwise be the most susceptible sites for nucleophilic and electrophilic attacks.^{[25]} IC-H also exhibits intermolecular multicenter non-linear hydrogen bonds between the amine and ketone groups of neighboring monomers protecting the indigo core again from the same reactive centers.^{[25]} This extensive hydrogen bond formation and the steric hindrance confer stability to the structure by blocking the probable sites of nucleophile and electrophile attacks. Thus, the extremely stable structure, high reversibility of the redox reaction, and high aqueous solubility of IC-H make IC-H a promising candidate as anolyte for AORFB.

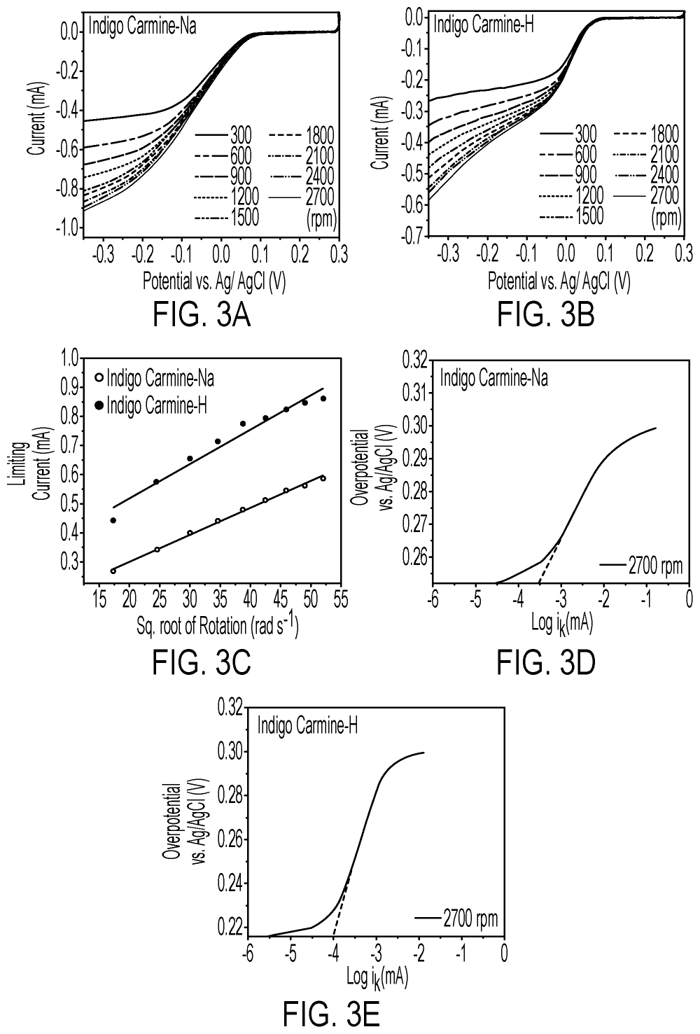

To gain further insights into the electrochemical kinetics, linear sweep voltammetry (LSV) of IC-Na and IC-H (FIGS. 3A-E) were conducted by using the classic rotating disk electrode (RDE) technique, where the glassy carbon disk was rotated at a variety of speed ranging from 300 rpm to 2700 rpm with an increment of 300 rpm, and the LSV scans were performed at 25 mV s¹ scan rate. The well-defined plateau observed at the LSV profiles of IC-Na and IC-H demonstrates the mass transport controlled limiting current, as depicted in FIGS. 3A and 3B, respectively. The limiting current of IC-Na and IC-H exhibits a linear relationship with the square root of rotation (FIG. 3C), which is in accordance with the Levich equation.^{[8]} The diffusion coefficients of the IC-Na and IC-H were calculated to be ˜3.38×10⁻⁵ and 2.23×10⁻⁵ cm² s⁻¹, respectively, using the slope of the Levich plots (the detailed calculations are shown in the experimental section). The diffusion coefficients obtained for IC-Na and IC-H are higher^{[5, 26, 27]} or comparable^{[8]} to the other recently investigated organic electrolytes. Subsequently, to determine the rate constant of the charge transfer process, reduction overpotential of IC-Na and IC-H versus the logarithm of currents were plotted, as shown in FIGS. 3D and 3E, respectively. The Tafel equation can be applied over 25 mV and 22 mV overpotential for the reduction of IC-Na and IC-H, respectively. In addition, the electron transfer rate constants of IC-Na and IC-H estimated from the fitted Tafel slopes (shown as the dashed line in FIGS. 3D and 3E) are 2.32×10⁻⁴ and 2.82×10⁻⁴ cm s⁻¹, which are comparable to the recent organic species and most of the inorganic materials investigated for AORFB.^{[12, 26, 28]} Although, the diffusion coefficient of IC-H is lower than that of IC-Na, its kinetic rate constant is slightly higher, which implies faster reaction kinetics of IC-H. Therefore, the fast mass transport and kinetic reduction rate constant obtained for the active species suggests a negligible voltage loss due to the rate of the electrochemical redox reaction at the surface of the electrode and ensures a high operational current density of the flow cell. Consequently, the obtained kinetic results further verify the feasibility of using IC-Na and IC-H as anolytes in AORFB.

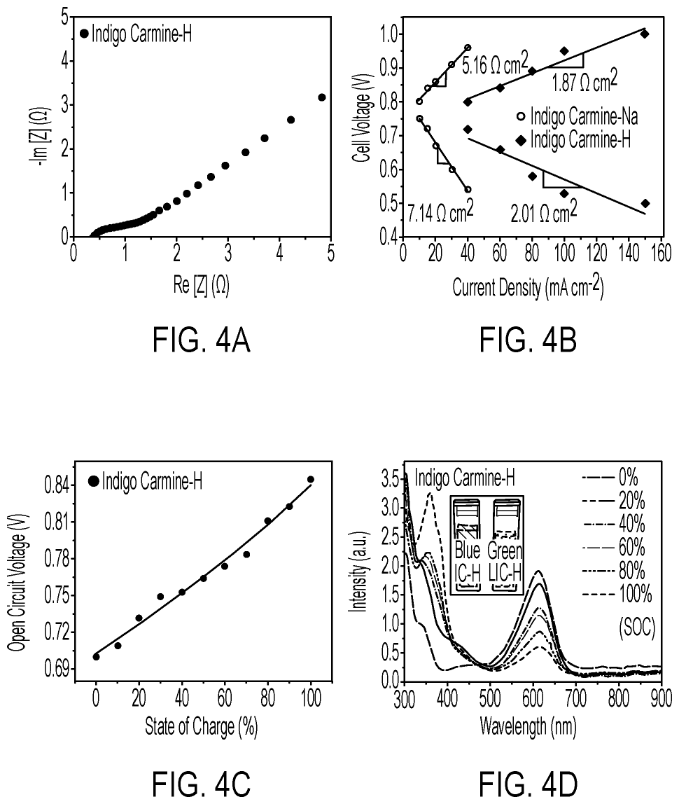

FIG. 4A is the measured Nyquist impedance spectrum at the open circuit of an IC-H/Br₂ flow cell in a static condition that shows a semi-circle at the high-frequency region and a straight line at the low-frequency region. The X-intercept of 0.35Ω in the high-frequency region of the curve represents the bulk resistance, which includes the solution resistance of the electrolyte, electrode resistance, contact resistance of each component, and the resistance contributed by the NAFION® membrane. The semicircle of diameter ˜0.6Ω represents minimal charge transfer resistance at the high-frequency region, which is consistent with the fast charge transfer constants of IC-Na and Br₂. The linear part indicates the resistance due to the diffusion of the electrolytes through the porous electrodes at low frequency. The cell can also obtain very low ASR, as displayed in FIG. 4B, as low as 1.87 S2 cm² on charge and 2.01 Ω cm² on discharge with excellent repeatability. The IC-H anolyte revealed an open circuit voltage (OCV) of 0.85 V when paired with Br₂/HBr, which is in well agreement with the predicted OCV of 0.89 V depending on the redox potential differences of Br₂/HBr (0.89 V vs. Ag/AgCl) and IC-H (˜0 V vs. Ag/AgCl). The OCV of the full cell increased uniformly from 0.70 V at 0% state of charge (SOC) to 0.85 V at 100% SOC (FIG. 4C), where the 0% and 100% SOC correspond to the fully discharged and charged states of the battery at a current density of 10 mA cm⁻². Further, to verify the reduction of the IC-H in the full cell, UV-Vis absorption spectra of IC-H were recorded during the charging process of the cell at 40 mA cm⁻² current density, 1.4 V upper voltage cut off, and at different SOC with wavelengths ranging from 300 nm to 1000 nm (FIG. 4D). At 0% SOC, the measured spectra of IC-H is in well accordance with the published spectra of IC-Na with two absorbance maxima at 335 nm and 610 nm within the wavelength range of 300-1000 nm, accreditable to the indigo group present as the chromophore center.^{[29]} However, during the charging process, the oxidized state (IC-H) and the reduced state (LIC-H) of the IC-H coexist in the electrolyte solution, which was verified by the fact that with increasing SOC, the intensity of the peak at 335 nm increases, whereas, the intensity of the other peak at 610 nm decreases linearly, indicating the increasing amount of LIC-H specie in the anolyte. The color of the anolyte also changes from blue at 0% SOC to green at 100% SOC, as shown in the inset of FIG. 4D. In addition, the color change of both the active electrolytes further suggest the occurrence of the redox reactions at both sides and appropriate operation of the cell.

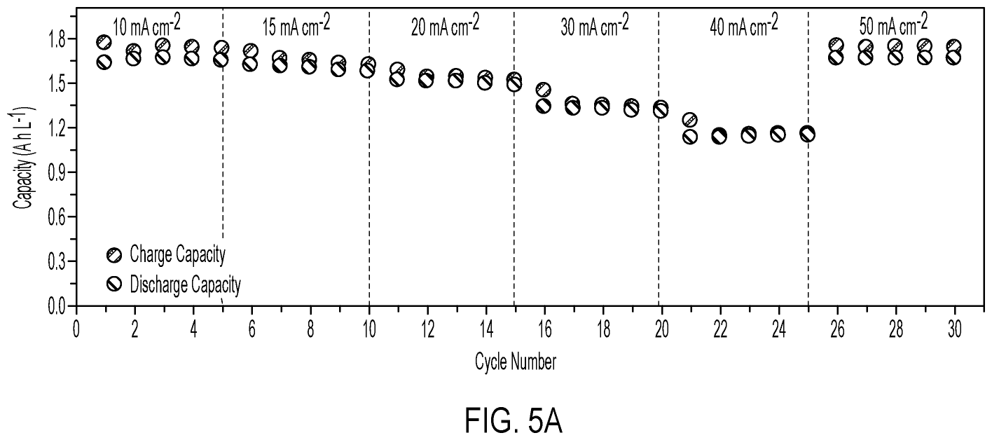

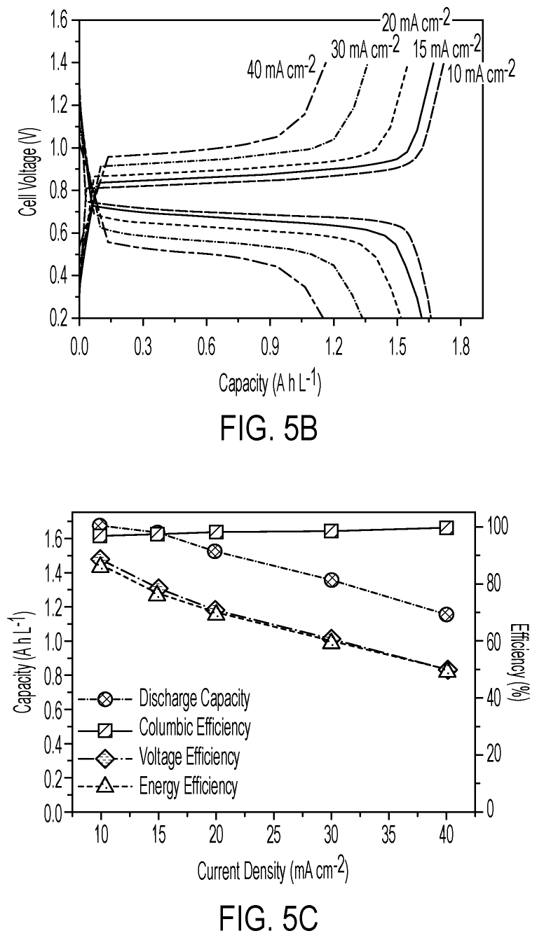

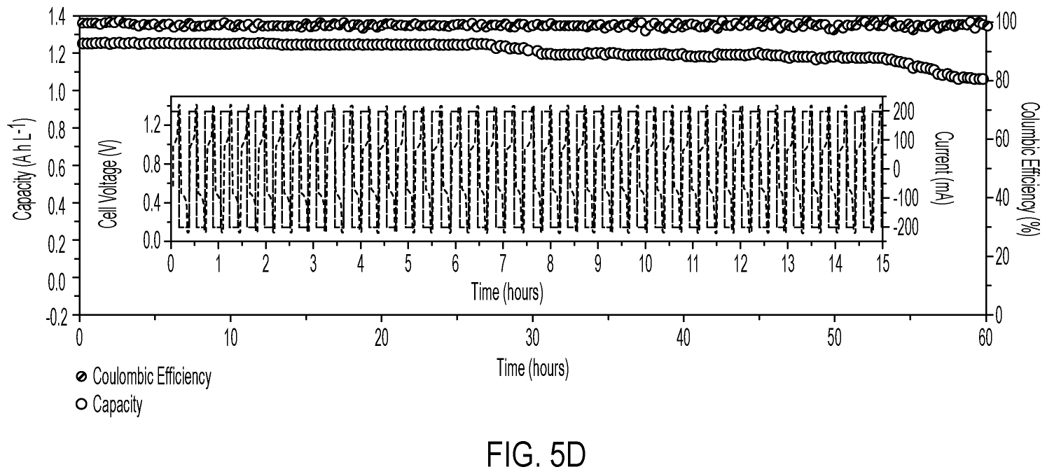

To gain further insight of the storage capability of IC-Na, the full cell tests were first performed using 0.035 M IC-Na in 0.1 M HClO₄ supporting electrolyte as negative electrolyte against 0.5 M Br₂ in 3 M HBr aqueous solution as a positive electrolyte and a NAFION® proton exchange membrane. The current rate performance of the full cell, as shown in FIG. 5A, was achieved by running the cell at six different current densities ranging from 10 mA cm⁻² to 40 mA cm⁻² for five consecutive times at each current density with a charge cut off voltage of 1.4 V, a discharge cut off voltage of 0.2 V, and returned to the initial current density of 10 mA cm⁻², where it regains 100% of its original capacity. Lower current densities are chosen for IC-Na/Br₂ cell compared to the IC-H and other potential AORFB electrolytes due to the limited solubility of IC-Na (0.035 M in 0.1 M HClO₄).^{[2, 8, 12, 26}] As presented in FIG. 5B, the IC-Na/Br₂ cell obtained discharge capacities of approximately 1.67, 1.63, 1.52, 1.35, and 1.15 Ah L⁻¹ at 10, 15, 20, 30, 40 mAcm⁻², respectively. As anticipated, the increased voltage gaps observed in the charge-discharge plots exhibit the reduction in the achieved capacity with the increase in current density, which is a result of the increased ohmic loss and mass transport limitations at higher current densities. Moreover, the full cell has obtained columbic efficiencies of 96.78, 97.25, 97.96, 98.41, and 99.34%, voltage efficiencies of 88.65, 78.43, 70.79, 60.63, and 50%, and round-trip energy efficiencies of 85.79, 76.27, 69.34, 59.67, and 49.67% at current densities of 10, 15, 20, 30, and 40 mA cm⁻² (FIG. 5C). Under similar conditions, the cell has also displayed a stable cycling performance for 200 successive cycles at 40 mA cm⁻², as demonstrated in FIG. 5D. The average capacity retention of the cell is 99.91% per cycle (equivalent to an average capacity fade rate of 0.09% per cycle) even after 60 hours (200 cycles) with a columbic efficiency of ˜97% throughout the cycles except for the first cycle due to the dissolved oxygen in the water, which is consistent with the CV results. The decent capacity retention displayed by the IC-Na/Br₂ cell verifies the electrochemical stability of the IC-Na. It is also worth noting that the IC-Na can obtain an energy density of 2.24 Wh L⁻¹ while paired with Br₂ with such a low concentration of 0.035 M, which can be further improved to 0.760 M by creating its acid analog. Therefore, it is evident that with proper optimization in structure, IC-Na can be a promising electrolyte for AORFB.

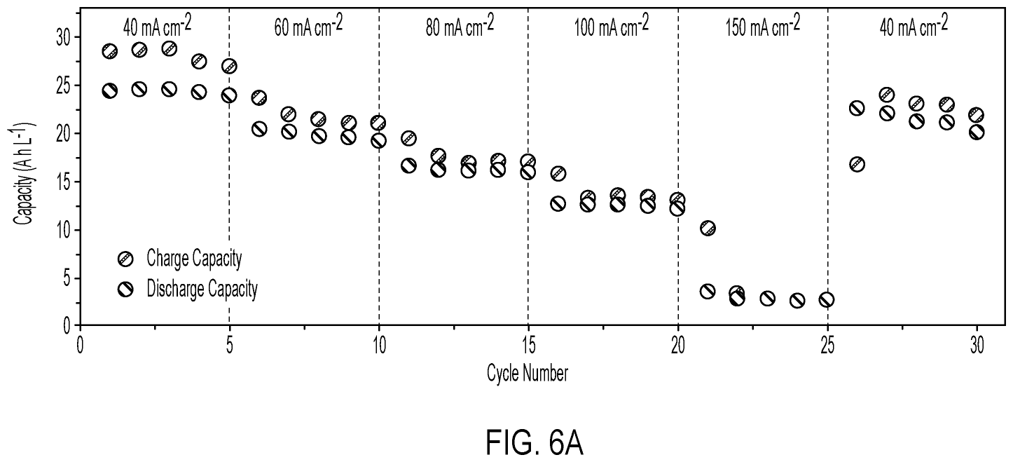

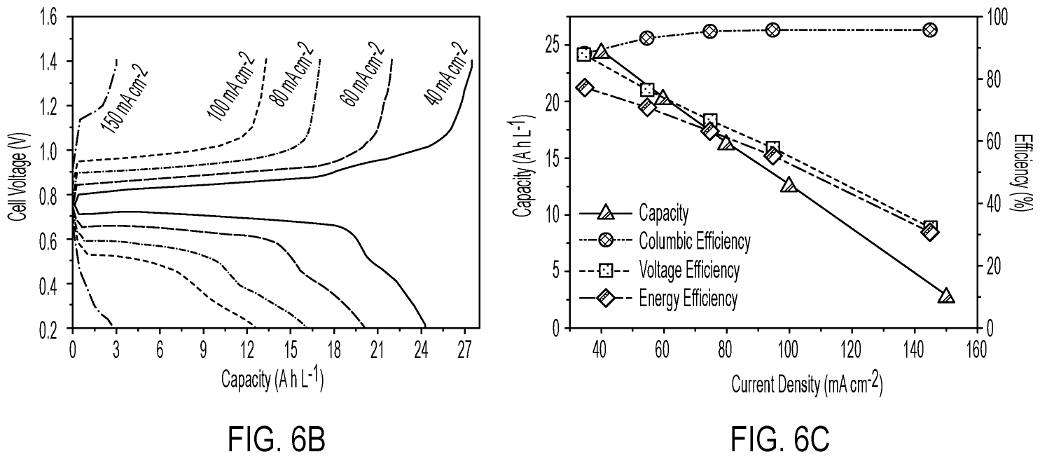

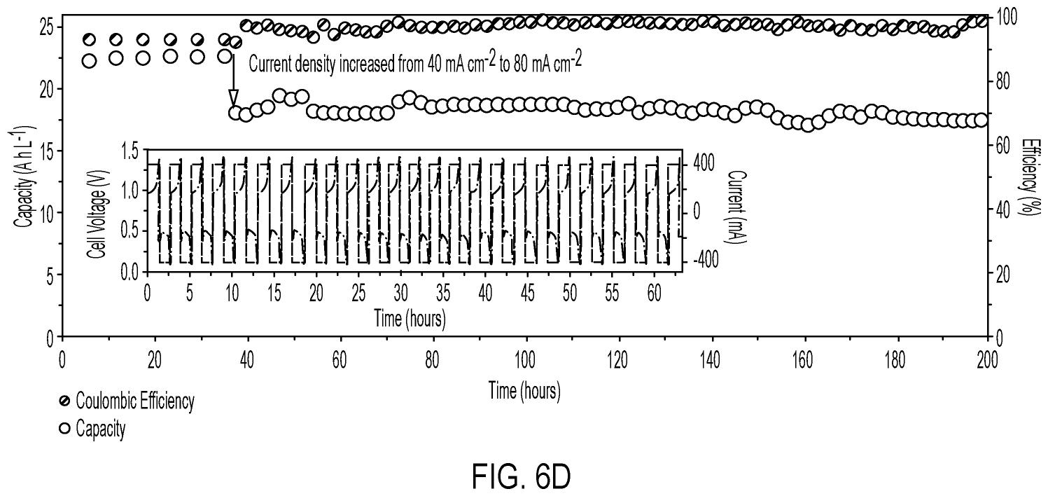

To demonstrate a high-performance AORFB, full cell performance of highly concentrated IC-H (0.7 M in 0.2 M HClO₄) was evaluated against Br₂/HBr (0.5 M Br₂ in 3 M HBr). The concentration of supporting electrolyte (HClO₄) was increased to 0.2 M for IC-H compared to the IC-Na since a higher concentration of IC-H was used. An excess volume of the catholyte was used compared to the anolyte to ensure the complete charge-discharge of the IC-H. To obtain the rate performance of the IC-H/Br₂ cell, it was cycled at different current densities, five times at each current density, ranging from 40 mA cm⁻² to 150 mA cm⁻² and returned to the original current density of 40 mA cm⁻² as shown in FIG. 6A. The IC-H exhibits excellent capacity retention with an average discharge capacity of 24. 2, 20.1, 16.1, 12.6, and 2.9 Ah L⁻¹ at 40, 60, 80, 100, and 150 mA cm⁻², respectively, and regains 84% of its initial capacity when returned to the initial current density that evidences much-enhanced rate performance of IC-H at even higher current densities compared to the IC-Na due to the high concentration of the redox active molecules. However, it should be noted that the experiment lasted for more than 100 hours and some visible Br₂ crossover was observed at the end of the experiment, which also explains the capacity fade during the last three cycles. FIG. 6B illustrates the typical charge-discharge profiles of IC-H/Br₂ cell at various current densities that exhibit a decrease in capacity at higher current densities owing to the increased ohmic loss, which is also consistent with the results obtained for IC-Na. The charge and discharge curves at each current density demonstrate two distinct plateaus, among which one is dominant and contributes to approximately 70-76% of the total capacity and the other one is weak and delivers the remaining 30-24% of the capacity. The existence of two plateaus during charge is probably due to the two electron enolization process, where the two ketone groups containing IC-H converts to two enol groups containing LIC-H by two successive symmetric protonation processes. According to Moreno et al., the relative activation energy of one protonation process is more than six times higher than the other protonation process.^{[24]} This significant difference in activation energy can cause different overpotential for the two successive protonation process of IC-H, which is also consistent with the shoulder obtained in the previously published CV^{[15]} of IC-Na.

Compared to IC-Na, IC-H delivers much-enhanced discharge capacities at higher current densities leading to an energy density of 20.6 Wh L⁻¹ with a corresponding power density of 48 mW cm⁻² at 40 mA cm⁻² and 13.7 Wh L⁻¹ energy density with a corresponding power density of 96 mW cm⁻² at 80 mA cm⁻² at 100% SOC. FIG. 6C shows the plot of discharge capacity, coulombic efficiency, voltage efficiency, and the energy efficiency at different current densities. The voltage efficiency of the cell decreased from 88% at 40 mA cm⁻² to 58% at 100 mA cm⁻² and to 33% at 150 mA cm⁻², whereas, the energy efficiency decreased from 77% at 40 mA cm⁻² to 55% at 100 mA cm⁻² and to 33% at 150 mA cm⁻². The cell exhibited coulombic efficiencies of 88.0, 93.0, 95.1, 95.5 and 96.0% at current densities of 40, 60, 80, 100 and 150 mA cm⁻², respectively. The voltage efficiency and the energy efficiency of the cell followed the typical trend of decreasing with an increase in current density. However, the coulombic efficiency exhibited a reverse trend of increasing with the increasing current density, which can be attributed to the increase in the discharge time at lower current densities. This reverse trend can be designated to the severe oxygen sensitivity of the reduced state of the IC-H which affects the overall coulombic efficiency of the cell. Even though the electrolytes chambers were sparged with nitrogen and sealed properly to prevent any oxygen exposure, it was not possible to annihilate oxygen from the system with the dynamic flow cell set up and the longer cycling time at low current density. However, this problem can be easily solved by running the cell in an inert environment. The effect of oxygen is more predominant with the increase in the discharge duration.

To further validate the stability of IC-H, the cell was cycled for 35 hours at a low current density of 40 mA cm⁻² and 165 hours at a high current density of 80 mA cm⁻² continuously and retained 96.83% of its initial capacity, as displayed in FIG. 6D. The average capacity retention of the cell is 99.54% per day, which is also identical to 0.04% capacity fade in each cycle, even after 200 hours with an average coulombic, voltage, and energy efficiencies of ˜96, 67, and 64% for high current density cycling at 80 mA cm⁻² and 93, 88, and 77% for the low current density cycling at 40 mA cm⁻², respectively. The inset of FIG. 6D exhibits the current and voltage profiles against time for 25 cycles at 80 mA cm⁻² current density.\ This outstanding stability of IC-H is attributable to the excellent structural stability arising from the inter/intramolecular hydrogen bonding and negligible crossover of the IC-H. Overall, the outstanding stability, efficiencies, energy, and power densities achieved for the novel, low cost, and environmental friendly IC-H provide a promising direction for sustainable, cost-effective AORFB.

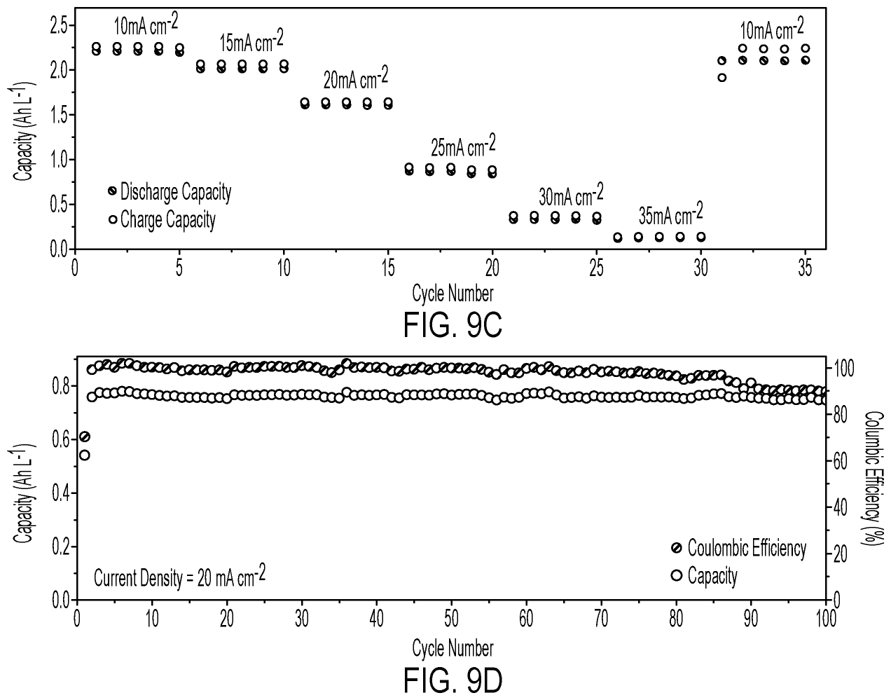

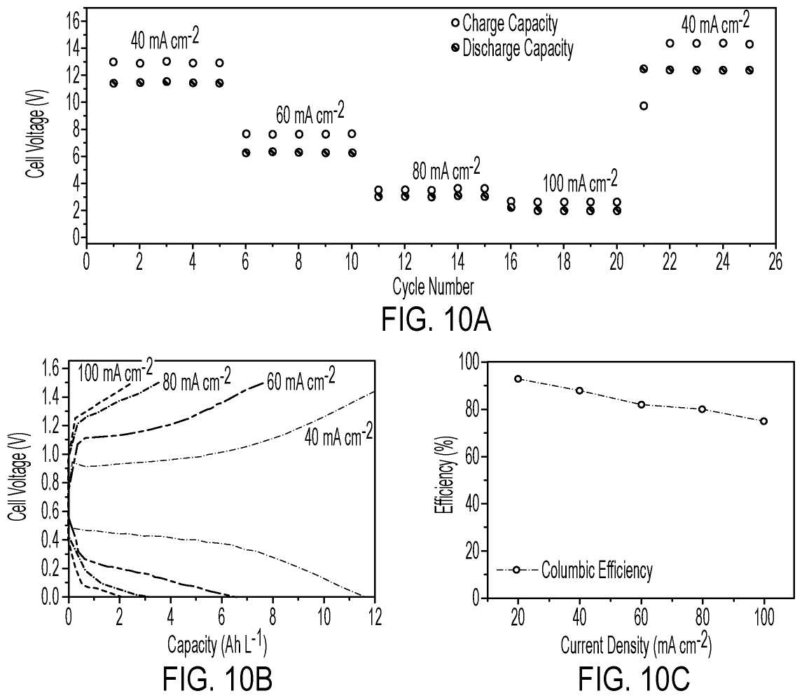

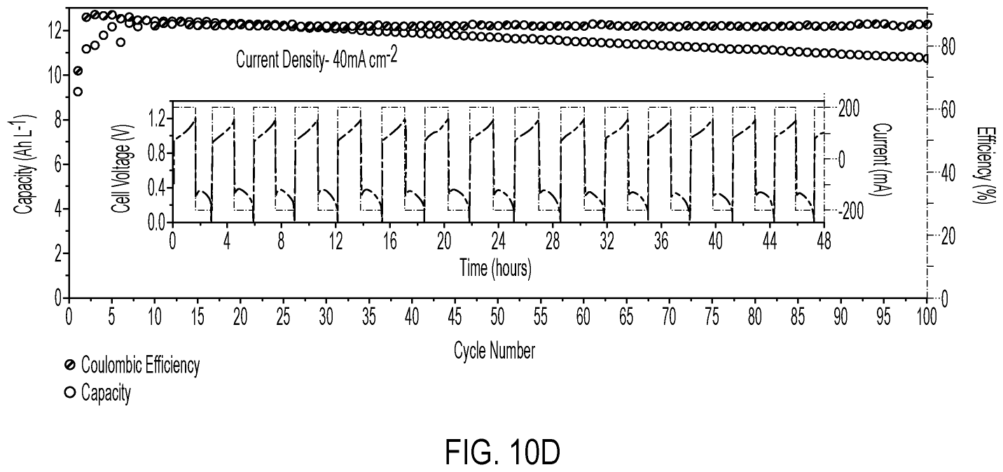

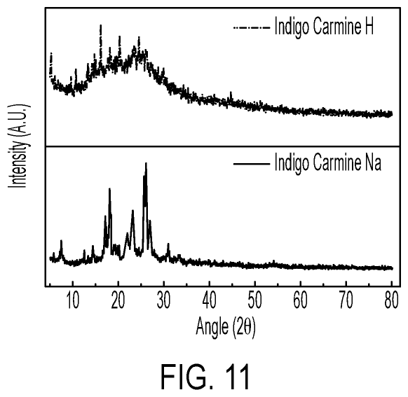

A current challenge for AORFB is to achieve a high energy density while minimizing the electrolyte cost and the developed design meets both of these requirements. However, using Br₂ as a catholyte raises serious safety concern due to the high toxicity of Br₂. Therefore, we have also paired IC-Na and IC-H with an organic TEMPO in 0.1 M HClO₄, which exhibits a pair of redox peaks around 0.75 V vs. Ag/AgCl leading to a full cell OCV of 0.75 V. The full cell tests of IC-Na/TEMPO (0.035 M IC-H in 0.1 M HClO₄) and IC-H/TEMPO (0.7 M IC-H in 0.1 M HClO₄) have also achieved very high capacities with excellent capacity retention, as illustrated in FIGS. 9A-D and 10A-D, respectively. However, the cell achieved much lower coulombic efficiencies than the IC-Na/Br₂ and IC-H/Br₂ cell, as the cell suffered from the high crossover rate of radical cation TEMPO through the cation exchange NAFION® membrane.

More improvements in the cell design can be made by further improving the solubility of IC-Na, decreasing the redox potential of IC-Na, or by changing the pH of the supporting electrolyte. Organic molecules allow optimization of the critical criteria needed for the flow battery such as achieving higher solubility by introducing the solubilizing group, different redox potential to increase the voltage window by tuning the electron donating properties of the functional groups and decreasing crossover by changing the size or net charge. These optimizations can easily be done by chemically modifying the molecules, which can further be enhanced by a prior computational study to predict the solubility and redox potential.

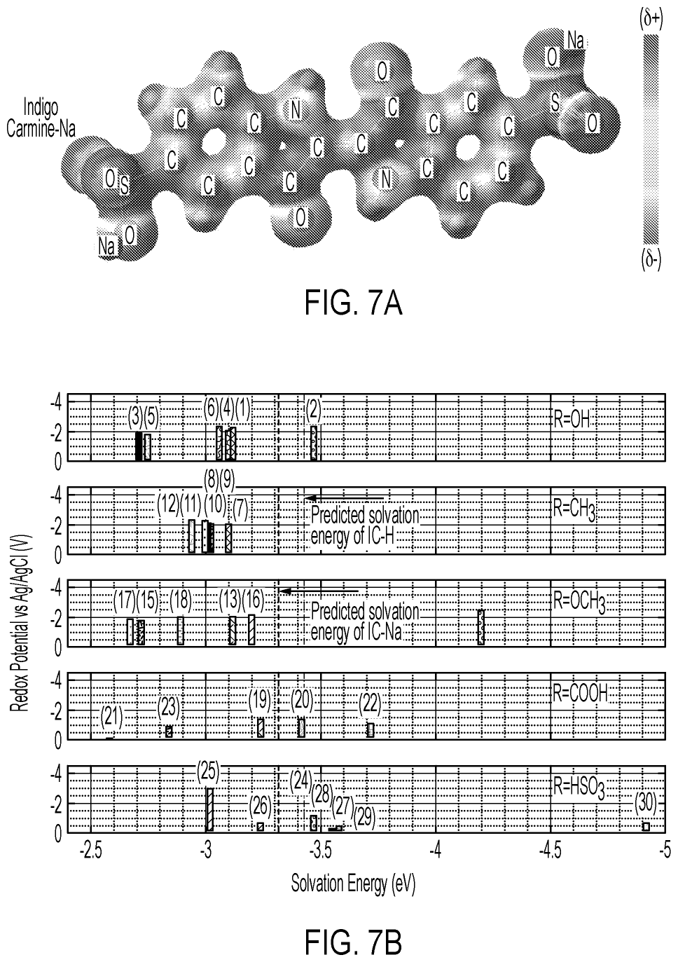

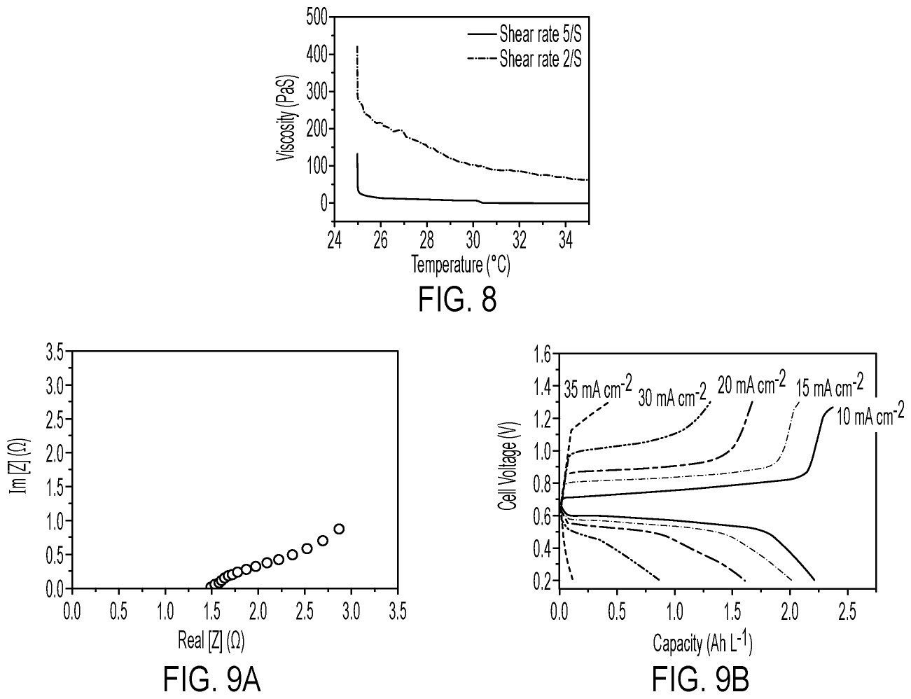

Therefore, to better understand the additive effect of various functional groups on the indigo backbone, a detailed computational study was performed using density functional theory (DFT) calculations. Different electron donating groups such as hydroxyl (—OH), methyl (—CH₃), methoxy (—OCH₃) and electron withdrawing groups such as carboxyl (—COOH) and sulfonic acid (—HSO₃) were selected to study the additive effect on the solubilities and redox potentials of the IC-Na derivatives. Shown in FIG. 7A, the electrostatic potential map of IC-Na indicates that the electron density in the IC-Na is mostly localized in the oxygen atoms of the ketone groups, while the most electron deficit regions are the H atoms of the phenyl and pyridine rings, thus making them more susceptible to the nucleophile attacks. Therefore, computations were carried out by inspecting all the possible substitutions for each functional groups at every possible site of the IC-Na. Thirty molecules with different substitutions were screened. Selected results together with the substitution pattern of potential anolyte candidates are listed in Table 1. FIG. 7B shows the variation in predicted standard redox potential with the introduction of different functional groups to the backbone of indigo. Addition of electron donating groups reduced the reduction potential drastically. Addition of hydroxyl, methyl, and methoxy lowered the redox potential drastically reaching up to −2.49 V vs. Ag/AgCl, as shown in FIG. 7B. Unexpectedly, the addition of electron withdrawing groups such as sulfonate and carboxyl lowered the cell potential for some configuration (FIG. 7B). Similar results were also observed by Hollas et al.^{[30]} Moreover, the predicted redox potentials are in neutral medium (pH 7) and can be corrected for the strong acidic medium of pH 1 by adding 0.354 mV (Equation 3), which is also consistent with the experimentally obtained redox potential of IC-Na and IC-H in neutral and acidic medium of pH 7 and 1, respectively. In addition, solvation energies of some of the derivatives are also higher than the solvation energy of IC-Na and IC-H (as represented in Table 1), indicating an improvement in the solubility. Therefore, the obtained computational results would be beneficial as an initial guideline for the selection of most promising candidates for AORFB anolyte among the various indigo derivates. The selected anolyte candidates should (1) have solvation energy lower than IC-Na (<−3.32 eV, on the right of the black dotted line in FIG. 7B) and (2) have a suitable redox potential depending on the potential of the catholyte to maintain the operational cell voltage within the water splitting voltage window, which is thermodynamically 1.23 V^{[31]} at standard conditions. Synthesizing the proposed molecules are beyond the scope of this work, but our future goal will be to synthesize the promising indigo derivates, verify the theoretical predictions, and evaluate their performance in the full cell against various catholytes.

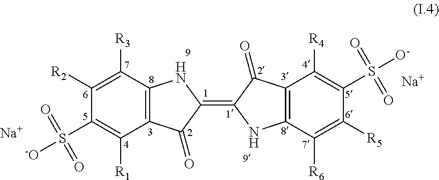

TABLE 1

| | | | | | | Redox |
|---|---|---|---|---|---|---|
| | | Positions of (I.4) | | | Solvation | potential |
| | Functional | 4 (R₁) | 6 (R₂) | 7 (R₃) | Energy | (E₀ V vs. |
| Index No. | Groups | 4′ (Rt) | 6′ (R₅) | 7′ (R₆) | (eV) | Ag/AgCl) |
| Indigo | No Substitution | | | | −3.32 | −0.40 |
| Carmine | | | | | | |
| Na | | | | | | |
| (measured) | | | | | | |
| Indigo | No Substitution | | | | −3.43 | −0.42 |
| Carmine H | | | | | | |
| (measured) | | | | | | |
| | | 1 Substituent | | | | |
| 1 | | R | H | H | −3.12 | −2.27 |
| 2 | | H | R | H | −3.47 | −2.32 |
| 3 | R = OH | H | H | R | −2.71 | −1.91 |
| | | 2 Substituent | | | | |
| 4 | | R | R | H | −3.10 | −2.09 |
| 5 | | R | H | R | −2.75 | −1.84 |
| 6 | | H | R | R | −3.06 | −2.35 |
| | | 1 Substituent | | | | |
| 7 | | R | H | H | −3.1 | −2.02 |
| 8 | | H | R | H | −3.02 | −2.08 |
| 9 | R = CH₃ | H | H | R | −3.00 | −2.06 |
| | | 2 Substituent | | | | |
| 10 | | R | R | H | −3.01 | −2.11 |
| 11 | | R | H | R | −3.00 | −2.28 |
| 12 | | H | R | R | −2.94 | −2.30 |
| | | 1 Substituent | | | | |
| 13 | | R | H | H | −3.12 | −2.08 |
| 14 | | H | R | H | −4.20 | −2.49 |
| 15 | R = OCH₃ | H | H | R | −2.72 | −1.81 |
| | | 2 Substituent | | | | |
| 16 | | R | R | H | −3.20 | −2.14 |
| 17 | | R | H | R | −2.67 | −1.91 |
| 18 | | H | R | R | −2.89 | −2.02 |
| | | 1 Substituent | | | | |
| 19 | | R | H | H | −3.24 | −1.37 |
| 20 | | H | R | H | −3.42 | −1.37 |
| 21 | R = COOH | H | H | R | −2.58 | −0.01 |
| | | 2 Substituent | | | | |
| 22 | | R | R | H | −3.72 | −1.07 |
| 23 | | R | H | R | −2.84 | −0.91 |
| | | 1 Substituent | | | | |
| 24 | | R | H | H | −3.47 | −1.21 |
| 25 | | H | R | H | −3.02 | −2.99 |
| 26 | | H | H | R | −3.24 | −0.68 |
| | R = HSO₃ | 2 Substituent | | | | |
| 27 | | R | R | H | −3.58 | −0.48 |
| 28 | | R | H | R | −3.55 | −0.22 |
| 29 | | H | R | R | −3.58 | −0.48 |
| | | 3 Substituent | | | | |
| 30 | | R | R | R | −4.92 | −0.68 |

In Table 1, the Index Nos. (rows) for Indigo Carmine Na and Indigo Carmine H reflect a measured redox potential, from which the solvation energy is calculated. The remaining 30 Index Nos. are computed values. The base structure is Structural Formula (I.4).

### CONCLUSIONS

In conclusion, we demonstrated a novel AORFB with a sustainable and low-cost organic dye that can be extracted from naturally abundant plants readily following scalable and inexpensive method with a 90% yield. The extracted parent dye indigo can easily be modified by an ion exchange chromatography using amberlysts 15 hydrogen resin to create its acid analog, which increases the solubility from 0.035 M to 0.76 M in 0.2 M HClO₄. In addition, IC-Na exhibits a reversible redox peak at 0 V vs. Ag/AgCl in 0.1 M HClO₄ with rapid reaction kinetics. Pairing the acid analog of IC-Na with Br₂/HBr enables a voltage window of 0.85 and an energy density of 20.6 Wh L⁻¹ with a corresponding power density of 48 mW cm⁻² at 40 mA cm⁻² current density. The full cell delivered an outstanding performance with an average round-trip energy efficiency of 77% at 40 mA cm⁻² current density. Further, the average capacity retention of each charge/discharge cycle was 99.54% per day. Moreover, tuning the structure of IC-Na can further enhance the aqueous solubility and boost the accessible capacity by increasing the voltage window. It is established that this approach of using naturally occurring organic dye as the active material for the flow battery can provide a low-cost and sustainable solution for the distributed energy storage.

### EXPERIMENTAL

### Materials and Synthesis

To obtain the IC-H from IC-Na, an ion exchange column was filled with Amberlysts 15 Hydrogen resin (Fisher Scientific) to ˜6-inch height and preconditioned by passing a 250 mL 0.1 M H₂SO₄ solution. Then the column was washed with DI water until the pH of the outcoming solution from the column is 7. After the conditioning step, 1 g of IC-Na dissolved in 100 mL of DI water was flushed through the column to convert the IC-Na to its acid equivalent IC-H. The whole process was repeated for three times. Then, the solvent was removed under controlled humidity, and the solid collected was dried under a vacuum at 70° C. for 48 hours.

### Three Electrode Electrochemical Characterization

Cyclic voltammetry experiments were performed using a Biologic SP150 potentiostat controlled by Biologic EC-Lab software. All linear sweep voltammetry (LSV) studies were conducted using a Biologic SP150 potentiostat in a three-electrode setup. A 3 mm diameter Teflon encased glassy carbon disk working electrode (Pine Research Instrumentation) was rotated from 300 rpm to 2700 rpm using a Pine MSR rotator system. A platinum foil counter electrode, an Ag/AgCl reference electrode, and Pine Instruments glassware was used for all the RDE studies. Before each experiment, the glassy carbon working electrode was polished on 600 grit paper to a mirror shine using 0.05 μm Alumina suspension (Allied High Tech Products), sonicated for 10 minutes in ethanol, followed by a 10-minute sonication in DI water. All LSV scans were logged at a rate of 5 mV s⁻¹ and to eliminate experimental error each experiment was repeated for three times. The limiting currents (i.e., the diffusion-limited current intensity) were measured at −0.3 V versus Ag/AgCl and plotted over the square root of the rotation rate (rad/s). The resulted plots were fitted to yield a straight Levich plot, where the slope defines the Levich equation, as presented in Equation 1.

Slope=0.620 nFAC_{O}D^{2/3}ν^{-1/6} (Equation 1)

n is the number of electrons involved in the reaction that is 2 for this case.

Faraday's constant F=96485 C mol⁻¹

electrode area A=0.1963 cm²

Indigo carmine's concentration C_{O}=1.0×10⁻³M

kinematic viscosity ν=0.0089 cm² s⁻¹ for 0.1 M Perchloric Acid solution

D is the diffusion coefficient

The calculations yielded the diffusion coefficients of IC-Na and IC-H as 3.378×10⁻⁵ and 2.232×10⁻⁵ cm² s⁻¹, respectively. A plot of overpotential versus log₁₀ (iₖ) (i_{K} indicates the kinetic current for the reduction of IC-Na and IC-H) were built for the LSV data obtained at 2700 rpm and the X-intercepts of the fitted Tafel plots implies the logarithm of the exchange current i₀. Further, the log (i₀) can also be represented as FAC_{O}k₀, where k₀ is the electron transfer rate constant. From the above relation, using the obtained data, k₀ was calculated to be 2.32×10⁻⁴ for IC-Na and 2.82×10⁻⁴ cm² s⁻¹ for IC-H.

### Flow Cell Electrochemical Characterization

The flow battery system consisted of a single battery cell assembly, two electrolyte tanks, peristaltic pumps for electrolyte circulation, temperature control equipment, and pressure monitoring equipment. According to the previously published protocol^{[5]}, the cell was assembled using two gold-plated aluminum current collectors, two machined graphite plates with integrated column flow field, and silicon gaskets. The assembly was held together by eight 10-32 socket head screws torqued to 25 in-lbs. During assembly, six carbon papers (Sigracet 39AA, 280 μm thick, 80% porosity) were stacked at each side, and a NAFION® 115 membrane (Chemours) was used as a separator. Carbon papers were pretreated by first sonicating in IPA for 5 minutes and soaking them into a 1:1 concentrated H₂SO₄ and HNO₃ mixture at 50° C. for 5 hours. The carbon papers were triple rinsed with DI water before use. The membrane pretreatment method involved a 12-hour soak in 0.1 M perchloric acid at room temperature, followed by triple rinsing in DI water prior to loading in the cell. The cell active area was 5 cm².

Electrochemical Impedance Spectroscopy (EIS) was performed by applying a sine voltage waveform of amplitude 10 mV added to an offset voltage. The frequency of the sine voltage was varied stepwise from 1 MHz to 10 mHz, with 10 points per decade in logarithmic spacing. The horizontal intercept of the Nyquist plot (a real component of the impedance) at the point where the imaginary component of the impedance was zero was multiplied by the geometric electrode area (5 cm²) to obtain the high-frequency ASR.

State of Charge (SOC) Determination

The flow cell was charged at 10 mA cm⁻², and 500 μL of anolyte was taken out from the anolyte tank during the charging process at certain time intervals. The completely discharged cell was considered as 0% SOC, and completely charged cell was considered to be at 100% SOC. The samples were subjected to a 100 fold dilution, and a 2 mL aliquot was taken from this dilution. The spectroscopic measurements were performed with an Agilent 8453 UV-Vis spectrometer (10 mm path length and quartz cuvette) at 1 nm intervals over the wavelength ranging from 300 to 1000 nm.

### Viscosity Measurement

Viscosity testing was performed on candidate solution of 0.7 M at 2 and 5 s⁻¹ shear rate within a temperature range of 25−40° C. using Discovery HR-2 Rheometer (TA instrument, USA).

### Conductivity and pH Test

Conductivity and pH measurements were taken using an Oakton pH/CON Portable Meter (PC 450). Calibration was done at room temperature using Oakton 1413 and 12880 μS conductivity standards (WD-00653-18, WD-00606-10), and Oakton 4 and 7 pH buffers (EW-00654-00, EW-00654-04).

### Theoretical Calculations

The initial conformation of IC was created using Gauss View 5, and the geometries were optimized to a minimum energy level using DFT calculations in Gaussian 09. The geometry optimization and the single point frequency calculations were performed using B3LYP with split valence double zeta (6-31G) or triple zeta (6-311G) basis sets with polarization functions “(d,p)” that enhances the chemical structure by adding flexibility to atoms in forming chemical bonds in any direction and the diffuse functions “+ and ++” that improves the predicted properties with extended electronic densities.^{[32]} We obtained the lowest error in the predicted redox potential of IC compared to the experimental using the basis set B3LYP/6-311G(d,p) (Table 2) and further calculations were done using the same basis set, as presented in FIGS. 7A-B. The free energies of solvation were calculated using the conductor-like Polarizable Continuum model (overlapping sphere) with water as a solvent following Equation 2. Although acidic supporting electrolyte was used in this work, the solvent used for the prediction was water due to lack of the details of dielectric properties of 0.2 M perchloric acid.^{[30}] In addition, it can be justified that the same assumption was made for all the compounds. Therefore, the predicted results could still reflect the solubility trend of the compounds relative to each other. To compare the changes in thermochemistry from the gas phase to aqueous solution, all the energetics related to solvation were analyzed in term of the Gibbs free energies. The shift from pH 7 to pH 1 was estimated combining the experimental and predicted redox potential and Nernst equation, as represented in Equation 3, which is ˜354 mV. Theoretical reduction potentials for the two electron two proton reaction were obtained from the gibbs free energy difference between the dianion and the neutral forms of indigo carmine.

### REFERENCES

[1] X. Wei, W. Pan, W. Duan, A. Hollas, Z. Yang, B. Li, Z. Nie, J. Liu, D. Reed, W. Wang, ACS Energy Letters 2017, 2, 2187.
[2] K. Lin, R. Gómez-Bombarelli, E. S. Beh, L. Tong, Q. Chen, A. Valle, A. Aspuru-Guzik, M. J. Aziz, R. G. Gordon, Nature Energy 2016, 1, 16102.
[3] J. D. Milshtein, J. L. Barton, T. J. Carney, J. A. Kowalski, R. M. Darling, F. R. Brushett, Journal of The Electrochemical Society 2017, 164, A2487.
[4] E. S. Beh, D. De Porcellinis, R. L. Gracia, K. T. Xia, R. G. Gordon, M. J. Aziz, ACS Energy Letters 2017, 2, 639.
[5] A. Mukhopadhyay, J. Hamel, R. Katahira, H. Zhu, ACS Sustainable Chemistry & Engineering 2018.
[6] M. R. Gerhardt, L. Tong, R. Gómez-Bombarelli, Q. Chen, M. P. Marshak, C. J. Galvin, A. Aspuru-Guzik, R. G. Gordon, M. J. Aziz, Advanced Energy Materials 2017, 7; K. Lin, Q. Chen, M. R. Gerhardt, L. Tong, S. B. Kim, L. Eisenach, A. W. Valle, D. Hardee, R. G. Gordon, M. J. Aziz, Science 2015, 349, 1529; W. Wang, W. Xu, L. Cosimbescu, D. Choi, L. Li, Z. Yang, Chemical communications 2012, 48, 6669.
[7] B. Yang, L. Hoober-Burkhardt, S. Krishnamoorthy, A. Murali, G. S. Prakash, S. Narayanan, Journal of The Electrochemical Society 2016, 163, A1442.
[8] T. Liu, X. Wei, Z. Nie, V. Sprenkle, W. Wang, Advanced Energy Materials 2016, 6, 1501449.
[9] X. Wei, W. Xu, M. Vijayakumar, L. Cosimbescu, T. Liu, V. Sprenkle, W. Wang, Advanced Materials 2014, 26, 7649.
[10] J. Luo, B. Hu, C. Debruler, T. L. Liu, Angewandte Chemie 2018, 130, 237.
[11] M. Park, J. Ryu, W. Wang, J. Cho, Nature Reviews Materials 2017, 2, 16080.
[12] B. T. Huskinson, M. Marshak, C. Suh, S. Er, M. Gerhardt, C. J. Galvin, X.
Chen, A. Aspuru-Guzik, R. G. Gordon, M. J. Aziz, 2014, 505, 195.
[13] B. Hu, C. Seefeldt, C. DeBruler, T. L. Liu, Journal of Materials Chemistry A 2017, 5, 22137.
[14] T. Janoschka, N. Martin, U. Martin, C. Friebe, S. Morgenstern, H. Hiller, M. D. Hager, U. S. Schubert, Nature 2015, 527, 78.
[15] J. Carretero-González, E. Castillo-Martínez, M. Armand, Energy & Environmental Science 2016, 9, 3521.
[16] S. Komboonchoo, T. Bechtold, Journal of Cleaner Production 2009, 17, 1487.
[17] S. T. Holmes, C. Dybowski, Solid state nuclear magnetic resonance 2015, 72, 90.
[18] J. König, in Colour Additives for Foods and Beverages, Woodhead Publishing, Oxford 2015, 35; B. P. Harp, J. N. Barrows, in Colour Additives for Foods and Beverages, Woodhead Publishing, Oxford 2015, 75.
[19] P. Vandenabeele, L. Moens, Analyst 2003, 128, 187.
[20] I. T. Shadi, B. Z. Chowdhry, M. J. Snowden, R. Withnall, Chemical Communications 2004, 1436.
[21] H. K. Song, G. T. R. Palmore, Advanced Materials 2006, 18, 1764.
[22] M. De Keijzer, M. R. Van Bommel, R. H.-d. Keijzer, R. Knaller, E. Oberhumer, Studies in Conservation 2012, 57, S87; S. Komboonchoo, T. Bechtold, Textile Research Journal 2010, 80, 734; T. C. Barden, in Heterocyclic Scaffolds II: Reactions and Applications of Indoles, (Ed: G. W. Gribble), Springer Berlin Heidelberg, Berlin, Heidelberg 2010, 31.
[23] E. Hamidi-Asl, J. B. Raoof, R. Ojani, M. S. Hejazi, Electroanalysis 2013, 25, 2075.
[24] M. Moreno, J. M. Ortiz-Sanchez, R. Gelabert, J. M. Lluch, Physical Chemistry Chemical Physics 2013, 15, 20236.
[25] H. Solis Correa, E. Ortiz, V. H. Uc, I. D. Barceló Quintal, J. L. Hernandez Avila, Molecular Simulation 2011, 37, 1085.
[26] L. Su, D. Zhang, S. Peng, X. Wu, Y. Luo, G. He, International Journal of Hydrogen Energy 2017, 42, 21806.
[27] Z. Yang, L. Tong, D. P. Tabor, E. S. Beh, M. A. Goulet, D. De Porcellinis, A. Aspuru-Guzik, R. G. Gordon, M. J. Aziz, Advanced Energy Materials 2018, 8, 1702056.
[28] T. Liu, X. Wei, Z. Nie, V. Sprenkle, W. Wang, Advanced Energy Materials 2016, 6, 1501449; C. S. Sevov, D. P. Hickey, M. E. Cook, S. G. Robinson, S. Barnett, S. D. Minteer, M. S. Sigman, M. S. Sanford, Journal of the American Chemical Society 2017, 139, 2924.
[29] A. Bentouami, M. Said Ouali, L.-C. de menorval, 1-s2.0-S1010603010000894-main, 2015.
[30] A. Hollas, X. Wei, V. Murugesan, Z. Nie, B. Li, D. Reed, J. Liu, V. Sprenkle, W. Wang, Nature Energy 2018, 3, 508.
[31] W. M. Haynes, Boca Raton-Lon-don-New York: https://www.crcpress.com/CRC-Handbo-ok-of-Chemistry-and-Physics-96th Edition/Haynes/p/book/9781482260977itgooglePreviewContainer; C. Xiang, K. M. Papadantonakis, N. S. Lewis, Materials Horizons 2016, 3, 169.
[32] M. J. Frisch, J. A. Pople, J. S. Binkley, The Journal of chemical physics 1984, 80, 3265.

### Supplementary Information

TABLE 2

| | Methods | | Deviation in redox Potential (mV) |
|---|---|---|---|
| PBE 6-31 G | | | 47 |
| | B3LYP | 6-21G | 49 |
| | | 6-31G | 42 |
| | | 6-31 + G | 44 |
| | | 6-31 + G** | 24 |
| | | 6-311G | 28 |
| | | 6-311G** | 8 |
| | | 6-311 + G | 22 |
| | | 6-311 + G** | 12 |

**Polarization has been taken into account in the ‘s’ orbitals and in the ‘p’ orbitals.

Solvation Free Energy Calculation

ΔG_{Solvation}=∈ₛ−{∈_{g}+G_{correction}} Equation 2

Where, ΔG_{Solvation} is the solvation energy (Hartree)

∈ₛ is the free energy of the solvated phase using the CPCM solvation model (Hartree)

∈_{g} is the free energy of the gas phase (Hartree)

G_{correction} is the thermal correction to the gibbes free energy (Hartree)

### Nernst Equation

$$E = {E}^{0} - \frac{RT}{n F} log Q = {E}^{0} - \frac{0.0 \; 592 V}{n} log Q \qquad Equation S3$$

Where R is the gas constant

T is the temperature

F is the Faraday constant

Q is the reaction quotient

### INCORPORATION BY REFERENCE; EQUIVALENTS

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. A redox flow battery comprising:
a) a first compartment with a first electrode and a first solvent or suspension therein, the first solvent or suspension comprising a first electrolyte dissolved or suspended therein;
b) a second compartment with a second electrode and a second solvent or suspension therein, the second solvent or suspension comprising a second electrolyte dissolved therein, wherein the second electrolyte is a compound having the following structural formula: 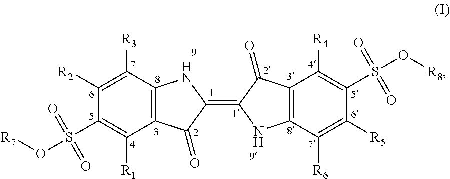
wherein each of R₁-R₆ is independently —H, —OH, —CH₃, —OCH₃, —COOH, or —SO₃H; and
wherein each of R₇ and R₈ is independently H, Na, or K;
c) an ion conducting membrane separating the first solvent or suspension and the second solvent or suspension.

2. The redox flow battery of claim 1, wherein R₇ and R₈ are H.

3. The redox flow battery of claim 1, wherein R₇ and R₈ are Na.

4. The redox flow battery of claim 1, wherein R₇ and R₈ are K.

5. The redox flow battery of claim 1, wherein each of R₁-R₆ is H.

6. The redox flow battery of claim 1, wherein each of R₁-R₈ is H.

7. The redox flow battery of claim 1, wherein each of R₁-R₆ is H, and wherein R₇ and R₈ are Na.

8. The redox flow battery of claim 1, wherein one or more of R₁-R₆ is —OH.

9. The redox flow battery of claim 1, wherein the first solvent or suspension further comprises HClO₄.

10. The redox flow battery of claim 1, wherein the second solvent or suspension further comprises HClO₄.

11. The redox flow battery of claim 1, wherein the first or second solvent or suspension has a pH from 2 to 6.

12. The redox flow battery of claim 1, wherein the first or second solvent or suspension comprises water.

13. The redox flow battery of claim 1, wherein the second solvent or suspension is a protic solvent.

14. The redox flow battery of claim 13, wherein the protic solvent comprises one or more of HClO₄, H₂SO₄, and HCl.

15. The redox flow battery of claim 1, wherein the first electrolyte comprises one or more of Br₂, HBr, and Br⁻.

16. The redox flow battery of claim 1, wherein the first electrolyte comprises TEMPO.

17. A method of operating a redox flow battery, the method comprising:
a) flowing a first solvent or suspension from a first storage tank to a first compartment, the first solvent or suspension comprising a first electrolyte dissolved or suspended therein;
b) flowing a second solvent or suspension from a second storage tank to a second compartment, the second solvent or suspension comprising a second electrolyte dissolved or suspended therein, wherein the second electrolyte is a compound having the following structural formula: 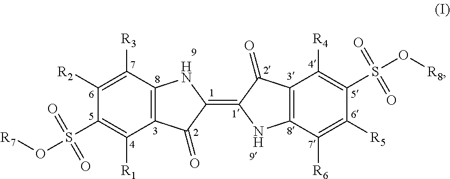
wherein each of R₁-R₆ is independently —H, —OH, —CH₃, —OCH₃, —COOH, or —SO₃H; and
wherein each of R₇ and R₈ is independently H, Na, or K.

18. The method of claim 17, further comprising generating electricity across a circuit connecting a first electrode and a second electrode, wherein the first electrode contacts the first solvent or suspension and the second electrode contacts the second solvent or suspension.

19. The method of claim 18, wherein generating electricity across the circuit comprises powering a load.

20. The method of claim 18, wherein generating electricity across the circuit comprises recharging the redox flow battery.
